(19) United States
(12) Patent Application Publication
(10) Pub. No.: US 2012/0148117 A1
(43) Pub. Date: Jun. 14, 2012

(54) SYSTEM AND METHOD FOR FACIAL IDENTIFICATION

(75) Inventor: Jae Young CHANG, Hwaseong (KR)

(73) Assignee: HYUNDAI MOTOR COMPANY, Seoul (KR)

(21) Appl. No.: 13/173,535

(22) Filed: Jun. 30, 2011

(30) Foreign Application Priority Data
Dec. 8, 2010 (KR) 10-2010-0124915

(51) Int. Cl. G06K 9/00

(52) U.S. Cl. 382/118

(57) ABSTRACT

The present invention is a system for providing facial identification, which includes a photography unit, a facial identification unit, a memory unit, and a controller. More specifically, the photography unit photographs a driver's face and the memory unit stores a user image or one or more image feature values which are registered to a first user ID. A user is identified by the facial identification unit which compares the driver's face photographed by the photography unit with a user image or one or more image feature values stored in the memory unit. If a positive identification cannot be made, however, a user input unit which is configured to receive a signal from user which requests that the driver's face photographed face be registered as a user image or one or more image feature values of the first user ID.

### CROSS-REFERENCES TO RELATED APPLICATIONS

Priority to Korean Patent Application Number 10-2010-0124915, filed on Dec. 8, 2010, which is incorporated herein by reference in its entirety, is claimed.

### BACKGROUND OF THE INVENTION

1. Field of the Invention

The present invention relates to a system and a method for facial identification, and more particularly, to a system and a method capable of registering a plurality of user images or image feature values to one user ID.

2. Description of the Related Art

Vehicle security has become a forefront technology in the automotive industry. As cars become more and more expensive, it becomes more and more important that they are protected from theft and unauthorized use.

To combat this, photographic devices located inside the vehicle can be used to take picture of driver's face and verify whether the driver has permission to use a particular vehicle. However, the performance of the photographic device equipped in the current facial recognition system is far from perfect. That is, in the current systems when a driver's face is photographed inside the vehicle, the photographed driver's face verified according to the direction and the intensity of sunlight on the driver's face. However, at night, the brightness intensity on a driver's face and the color variations of e.g., a person's skin/hair can occurred due to the lack of ambient sunlight. Thus, when photographing the driver's face at night, often time the size, and image quality of the driver's face can be greatly affected to due to the poor lighting at night.

Thus, there is a current need for a system and method which provides user identification of the driver's face regardless of the driver's condition and environment conditions surrounding the driver while at the same time minimizing misidentification of a user.

### SUMMARY OF THE INVENTION

The present invention setting a vehicle system according to a plurality of user images or one or more image feature values. Additionally, the present invention provides a system and a method for facial identification that minimizes the misidentification of face, and allows for reception of user feedback in response to an error in facial identification through a user input port.

In accordance with one embodiment of the present invention, a system for providing facial recognition is provided that includes a photography unit which is configured to photograph a driver's face and a memory unit which is configured to store an image of a user or an image feature value which is registered/associated with a first user ID>. Accordingly, a facial identification unit identifies a user by comparing the driver's face photographed by the photography unit with the image of the user or one or more image feature values stored in the memory unit.

As a way to register the user's face, the present invention, implements a user input unit and a controller. The user input unit receives signals from the user and the controller registers the driver's face as the user image or the one or more image feature values with the first user ID based on a signal inputted from the user input unit. Incidentally, when there is a facial identification unit fails to identify the users/driver's face, the user may register the current photographic image of the driver and one or more feature values with the first user ID as well by inputting the a signal through the user input unit.

In accordance with another aspect of the present invention, a method of facial identification may also include photographing a driver's face; comparing the driver's face with a user image or one or more image feature values registered to a first user ID to perform user identification; and registering the driver's face as the user image or image feature value for the first user ID based on a signal inputted from the user, in case the user identification has failed.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a configuration of a system for facial identification according to an exemplary embodiment of the present invention; and

FIG. 2 is a flowchart illustrating a facial identification method according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

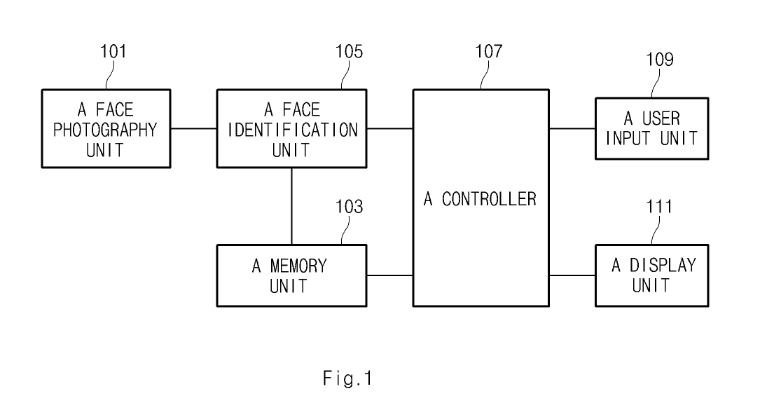

FIG. 1 is a block diagram illustrating a configuration of a system for facial identification according to an exemplary embodiment of the present invention.

As shown in FIG. 1, the facial identification system includes a photography unit 101, a memory unit 103, a facial identification unit 105, a controller 107, a user input unit 109, and a display unit 111. The photography unit 101, e.g., a camera, is a device which photographs a driver's face. The photography unit 101 automatically photographs a driver's face, in response to turning over the ignition of vehicle, or alternatively, after the driver's door is opened and then closed. That is, when driver enters the car and starts the car, the driver's face is automatically photographed by the unit 101. This photograph is then compared to one or more user images or feature values which are stored in the memory unit 103. These user images or feature values are a registered to, for example, a first user ID which is associated with a specific user.

User IDs are generated when a user initially registers a first image of their face with the user registration unit. The registered user image can be an image taken by the photography unit 101 or an image uploaded manually. Each image also has one or more image feature values. An image feature value is calculated by e.g., a Principal Component Analysis (PCA) based Eigen-Face, Linear Discriminant Analysis (LDA), and a Uniform Local Binary Pattern (ULBP) block histogram. Accordingly, image feature value does not vary according to sunlight or illumination and can maintain a uniform value for the same person. The feature value is extracted from the photographed driver's face, and, in general, is smaller than the size of the user image or the photographed driver's face, so that the capacity of memory unit 103 may be more efficiently used as well. The facial identification unit 105 compares the user image or the image feature value stored in the memory unit 103 with the driver's face photographed by the photography unit 101 to perform user identification. That is, the facial identification unit 105 extracts the image feature value from the driver's face photographed by the photography unit 101, and compares it with the image feature value stored in the memory unit 103, so that it can perform user identification/verification. In addition, in case only a user image is stored in the memory unit 103, an image feature value may alternatively, in this instance, be extracted from the user image and compared with the image feature value of driver's face photographed by the photography unit 101.

The controller 107 manages the first user ID stored in the memory unit 103 and a user image registered to the first user ID, and can additionally register a new image as a user image or one or more image feature values to the same user ID. The controller 107 also register the new image itself as the primary user image, and can automatically register the image feature value by abstracting the feature value of new image.

In some embodiments of the present event, the controller 107 registers and stores just the image feature value in the memory unit 103 so as to minimize the capacity of the memory unit 103.

In the event successful user identification has been made by the facial identification unit 105 succeeds in user identification, the controller 107 configures the vehicle systems by applying a set value, associated with the identified user ID, to the vehicle system which operates various components of the vehicle. For example, a set value can be associated with various vehicular function, such as, the inside temperature of the vehicle, a radio frequency, a navigation setting, a side mirror angle, and a driver seat setting. That is, each function, such as those listed above, may be controlled according to a set value that is in response to identifying a specific user via the facial identification unit.

Meanwhile, a positive identification of the driver/user is not made, the controller 107 may optionally, based on a user selection, register the driver's face photographed by the photography unit 101 as the user image or the image feature value with respect to the first user ID or a second user ID. A positive identification cannot be made when the photographed driver's face is not clearly recognized by the facial identification unit 105. A failure of the facial identification system can also occur when a driver/user is misidentified. That is, the photographed driver's face is recognized as user image or image feature value, but corresponding user ID is associated with a different user. In case the misidentification, the user is provided with the vehicle system having a set value corresponding to the third party user ID rather than his or her associated set value. In this situation, the driver's face should be photographed again and the vehicle system should be modified accordingly.

To avoid misidentification, however, the controller 107, in the illustrative embodiment of the present invention, controls the user identification process of the facial identification unit 105 so as to minimize the misidentification.

For example, in the sensitivity of the identification process can be increased by lowering a threshold associated with the comparison method. That is, the threshold in a way which more precisely identifies and recognizes various drivers faces.

In addition, when a user identification failure has occurred, the controller 107 can generate a second user ID and register the driver's face photographed by the photography unit 101 as the user image or image feature value for the second user ID, so that that driver may be registered as well as an authorized driver of the system.

In case an error occurs in user identification performed by the facial identification unit 105, the controller 107 can register the photographed user's face as user image or image feature value based on a signal inputted through a user input unit 109. That is, the user can request the registration of photographed driver's face through the user input unit 109. The user input unit 109 can be embodied in the form of touch screen or the like. Accordingly, the display unit 111 can display the driver's face photographed by the photography unit 101, the user image or image feature value stored in the memory unit 103, the result of user identification performed by the facial identification unit 105, and a confirmation window which asks user whether the photographed driver's face should be used as a user image.

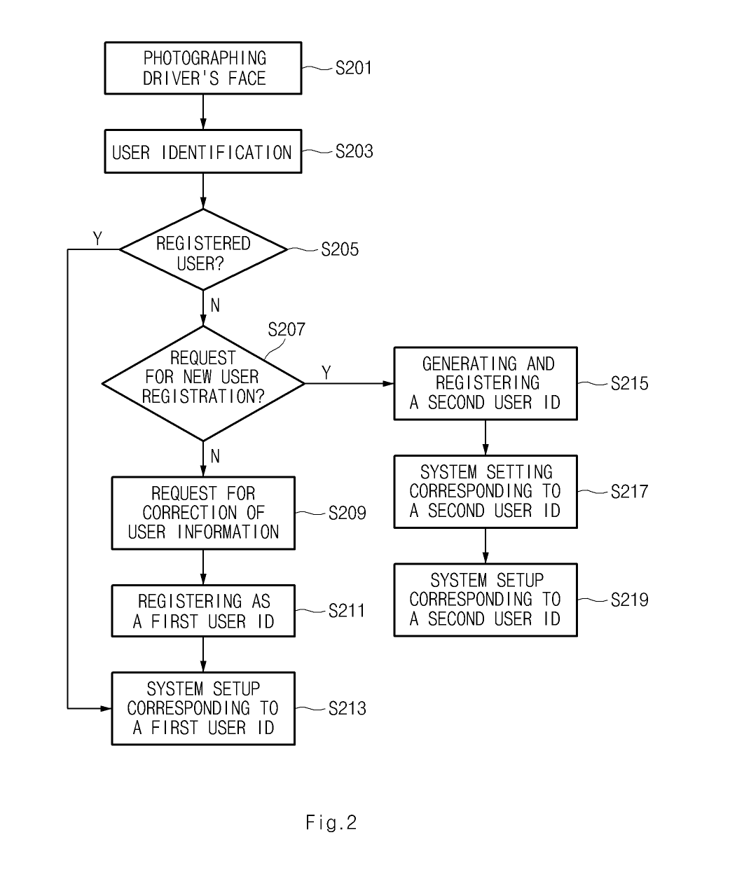

FIG. 2 is a flowchart illustrating a facial identification method according to an exemplary embodiment of the present invention.

As shown in FIG. 2, the method initiates with a driver's face being photographed, immediately after the ignition of the vehicle is turned on, or after the driver's door is opened and then closed (S201). Then, user identification is performed by using the photographed driver's face and a user image or one or more image feature values registered to a particular user ID (e.g., a first user ID) (S203). As a result of user identification, it is determined whether the photographed driver's face is the same as the face in the user image or one or more image feature value registered for the first user ID (S205). If a positive identification of the user is made in step 205, a set value of vehicle system corresponding to the first user ID is applied to configure the vehicle system accordingly (S213). When, however, a positive identification is not made, a user has the option of requesting a new user registration with the system in (S207). As a result of step 207, when a new user registration is not requested, a request for information correction may be inputted from the user (S209).

In response to step 209, the photographed driver's face is registered as a user image or one or more image feature values which are associated with the first user ID (S211). Then, the set value of vehicle system corresponding to the first user ID is applied to configure the vehicle system specifically for that user (S213).

Alternatively, when a new user registration is requested in step 207, a second user ID is generated and the photographed driver's face is registered as a user image or one or more image feature values for the second user ID (S215). Then, a vehicle system corresponding to the second user ID is set (S217). That is, a vehicle system according to new user can have a new or different set value which correlates to different vehicle settings and functions. In response to the second user ID's set value being configured or set, the vehicle system is configured the vehicle according to the set value corresponding to the second user ID (S219). The present invention can be implemented in a form of a computer readable code which is executed by a processor in a recording medium. The recording medium can include, for example, a ROM, a RAM, a CD-ROM, a magnetic tape, a floppy disk, and an optical data storage device. Advantageously, a user can be rapidly provided with a set value associated with a particular configuration of a vehicle by facial recognition. Additionally, facial identification may be more precisely analyzed by allowing the system to associate plurality of user images a registered user as well as one or more feature values, thus minimizing misidentification of a user.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A system of facial identification, the system comprising:
a photography unit configured to photograph a driver's face;
a memory unit configured to automatically store a user image or one or more image feature values which are registered to a first user ID;
a facial identification unit configured to perform user identification by comparing the driver's face photographed by the photography unit with the user image or one or more image feature values stored in the memory unit;
a user input unit configured to receive a signal from user; and
a controller which is configured to register the driver's face as a user image or the one or more image feature values to the first user ID based on a signal inputted from the user input unit, in response to a failure in the facial identification by the facial identification unit.

2. The system according to claim 1, wherein the controller minimizes facial misidentification of a user by allowing a user to adjust a threshold associated the precision of the facial identification unit.

3. The system according to claim 1, wherein, in response to a positive identification, the controller applies a set value associated with the first user ID to a vehicles configuration.

4. The system according to claim 1, wherein the controller generates a second user ID, and registers the driver's face as a user image or one or more image feature values to the second user ID.

5. The system according to claim 4, wherein the vehicle system is selected from a group consisting of a vehicle inside temperature, a radio frequency, a navigation setting, an angle of side mirror and a driver seat setting.

6. The system according to claim 1, wherein, the photography unit automatically photographs driver's face, after an ignition of vehicle is turned on, or after a driver door is opened and closed.

7. The system according to claim 1, wherein the user input unit a touch screen device.

8. The system according to claim 1, further comprising a display unit which displays a result of the user identification performed by the facial identification unit to the user.

9. The system according to claim 1, wherein the facial identification unit extracts one or more image feature values from the driver's face photographed by the photography unit and compares it with one or more image feature values stored in the memory unit to perform the user identification.

10. The system according to claim 1, wherein the facial identification unit extracts one or more image feature values from the user image stored in the memory unit and compares it with the driver's face photographed by the photography unit to perform the user identification.

11. A method of facial identification, the method comprising:
photographing, by a photographing unit, a driver's face;
comparing, by a facial identification unit, the driver's face with a user image or one or more image feature values registered to a first user ID to perform user identification; and
in response to a failed facial identification, registering, by a controller, the driver's face as the user image or one or more image feature values to the first user ID based on a signal inputted from the user.

12. The method according to claim 11, wherein comparing one or more image feature values minimizes misidentification in a user identification process.

13. The method according to claim 11, further comprising in response to a positive identification by the facial identification unit, applying a set value of a vehicle system according to the first user ID.

14. The method according to claim 11, further comprising generating a second user ID and registering the driver's face as a user image or one or more image feature values to the second user ID.

15. The method according to claim 14, wherein the vehicle system is at least one selected from a group consisting of a vehicle inside temperature, a radio frequency, a navigation setting, an angle of side mirror and a driver seat setting.

16. The method according to claim 11, further comprising displaying a result of the user identification on a display unit.

17. The method according to claim 11, wherein comparing further comprises extracting one or more image feature values from the photographed driver's face and comparing the extracted one or more image feature values with the one or more registered image feature values to perform a user identification.

18. The method according to claim 11, wherein comparing further comprises extracting one or more image feature values from the registered user image and comparing the extracted one or more image feature values with the photographed driver's face to perform a user identification.
